(19) United States
(12) Patent Application Publication
(10) Pub. No.: US 2015/0360438 A1
(43) Pub. Date: Dec. 17, 2015

(54) LAMINATE FLOOR LINER

(71) Applicants: Geoffrey Mial Baldwin, Mechanicsville, VA (US); Joshua Almon Elliott, Richmond, VA (US)

(72) Inventors: Geoffrey Mial Baldwin, Mechanicsville, VA (US); Joshua Almon Elliott, Richmond, VA (US)

(73) Assignee: SPECIALTY COATING & LAMINATING, LLC, Doswell, VA (US)

(21) Appl. No.: 14/303,626

(22) Filed: Jun. 13, 2014

(51) Int. Cl. B32B 5/02; B32B 5/24; B60N 3/04; B32B 5/32; B32B 27/08; B32B 23/08; B32B 5/26

(52) U.S. Cl. CPC B32B 5/024; B32B 5/022; B32B 23/08; B32B 5/245; B32B 5/26; B32B 5/32; B32B 27/08; B60N 3/048; B32B 2255/26; B32B 2605/003; B32B 2250/05; B32B 2305/188; B32B 2305/20; B32B 2305/022

(57) ABSTRACT

A laminate vehicle floor liner includes a core backing layer that is coated on either side with a polymer layer. The polymer layers act as moisture barriers to prevent water moisture and vapor from seeping into and degrading the core backing material. The liner may further include a reinforcing layer and third polymer layer laminated onto it. The polymer layers lock in and create a moisture barrier for the encapsulated backing and reinforcing layers.

This invention relates to vehicle floor assemblies, and specifically to a laminate vehicle floor liner. The liner provides a bottom moisture barrier polymer film to help prevent moisture from seeping into the core backing material. Additionally, the floor liner has a moisture barrier polymer film as a top layer to prevent the compromise the backing layer of the liner.

### BACKGROUND

Vehicles including cars and trucks are widely used and in many cases are widely used for a large number of years. This use can result in the exposure of a vehicle underside to corrosive environmental and road conditions. For instance, especially in colder climates and in coastal environments, the underside may be exposed to corrosive salts or other treatments. These environmental conditions may create the exposure of a vehicle floor to moisture from the corrosion of the underside of the vehicle during even ordinary use.

Existing floor liners may include moisture and vapor barrier layers in addition to a physical backing layer generally. However, existing floor liner constructions merely serve as a barrier to moisture and vapor that comes from underneath the floor of a vehicle. Especially when a floor liner includes a paper or other cellulosic backing layer, the moisture and humidity that may be exposed to the liner from the top of the liner may cause degradation of the liner over time.

### SUMMARY

Accordingly, it is an object of the present invention to overcome the drawbacks of existing automobile floor liner products. The present invention is directed to a floor liner that comprises a backing layer and first and second polymer layers laminated onto the top and bottom sides of the backing layer in order to protect that backing layer from moisture ingress originating from underneath the floor as well as from above the floor.

In one example, a laminate vehicle floor liner comprises a backing layer with a top side and bottom side. A first polymer layer and a second polymer layer are laminated onto the top and bottom sides of the backing layer respectively. The backing layer is selected from the group consisting of cellulosic material, a woven or nonwoven polymer fabric, polyurethane foam, and combinations thereof. The backing layer may be made of a paper, a Kraft paper, or a fiber board. Alternatively, the cellulosic material of the backing layer maybe impregnated with an additive selected from the group consisting of a resin, an adhesive, a urethane, a polyester and mixtures thereof. The floor liner may further include a reinforcing layer laminated onto the second polymer layer, wherein the reinforcing layer is selected from the group consisting of a cellulosic material, a woven or nonwoven polymer fabric, polyurethane foam, and combinations thereof. In this example, a third polymer layer may be laminated onto the side of the reinforcing layer that is opposite the second polymer layer.

In another example, a vehicle floor assembly comprises a floor and laminate liner bonded thereto. The laminate vehicle floor liner comprise a backing layer with a top side and bottom side and having a first polymer layer and a second polymer layer laminated onto the top and bottom sides of the backing layer respectively. The backing layer of the laminate liner may be comprises of a material selected from the group consisting of a cellulosic material, a woven or nonwoven polymer fabric, a polyurethane foam, and combinations thereof. The first polymer layer is bonded to the floor. In another example, the first and second polymer layers are substantially impermeable to water, moisture and vapor. The first and second polymer layers may be comprised of polyethylene. The backing layer may be comprises of a fiber board, and the reinforcing layer may be comprised of a woven polymer fabric.

### BRIEF DESCRIPTION OF THE DRAWINGS

FIG. 1 is a cross sectional view of an example of the laminate of the vehicle floor liner described herein.

FIG. 2 is a cross sectional view of a second example of a laminate vehicle floor liner as described herein.

FIG. 3 is a cross sectional view of a third example of a laminate vehicle floor liner as described herein.

FIG. 4 is a cross sectional view of a fourth example of a laminate vehicle floor liner as described herein.

### DETAILED DESCRIPTION

It is a purpose of the vehicle floor liner products described herein to provide a rugged and durable floor liner product that can withstand repeated exposure to moisture over time. A rugged backing layer is encapsulated between polymer film layers laminated on either side thereof. In some examples, there is an additional reinforcing layer that is laminated onto one side of the liner and that is likewise encapsulated with an additional polymer layer laminated onto the opposite side of the reinforcing layer from the rest of the liner product. In a still further example of a liner, an adhesion promoting layer may be laminated onto one side of the liner to improve the bond between the liner and a vehicle floor.

The vehicles that may benefit from this floor liner product include mobile homes, recreational vehicles, sport utility vehicles, trucks and automobiles generally. The liner is attached to the bed of the vehicle, and the floor is on the opposite side of the liner product from the bed of the vehicle. The liner product may be laminated directly onto the backside of the flooring product. Alternatively, they may be adhered to each other before or after installation into a vehicle.

Each of the backing layer, reinforcing layer, three polymer layers, and optional adhesion promoting layer will be discussed herein. As earlier noted, the liner may include solely a backing layer with first and second polymer film layers laminated onto either side of the backing layer. Alternatively, a reinforcing layer may be further laminated onto the second polymer layer. Still further alternatively, the liner may include a third polymer film layer that is laminated to the reinforcing layer on the opposite side of the reinforcing layer from the second polymer layer, thereby also encapsulating the reinforcing layer between polymer layers. It is readily apparent that both the backing layer and reinforcing layer, as a result of their encapsulation between polymer layers, are protected from moisture ingress that may damage or otherwise compromise the backing and reinforcing layers.

The backing layer is the substantial, physical core of the overall liner product. The backing layer may be formed of a cellulosic material, a woven or nonwoven polymer fabric, polyurethane foam, or combinations thereof. In the alternative of a cellulosic material, the backing layer may be formed from paper, for instance, Kraft paper, or other liner board material. In one example, the backing layer may be a 69 pound Kraft liner board. Alternatively, the backing layer may be a Kraft liner board ranging from 33 pounds to 90 pounds. This cellulosic material can include sizing such as resin or starch, or for example alkyl succinic anhydride (ASA) or alkyl ketene dimer (AKD).

In the example of a polymer fabric, it is possible to use a nonwoven polymer fabric of polypropylene or polyethylene terephthalate (PET) ranging from 50 g/m² to 180 g/m². This nonwoven polymer fabric can likewise include a sizing or coating to improve its hydrophobic nature. In the example of a woven polymer fabric, the fabric may be comprised of polyethylene or polypropylene. This could include high density polyethylene or also polyester (PET) or fiberglass scrims of different structures. In one example, the polymer fabric may include 8×8 (tapes per inch) woven polyethylene fabric or polypropylene fabric. The weight of this fabric in one example is 65 g/m², but alternatively it could range from 50 g/m² to a 200 g/m² fabric. Various polyurethane foams may also be used that have a density range of 0.8 to 2.0 lbs/ft³, in one example 1.5 lbs/ft³. Finally, combinations of the foregoing cellulosic, polymer fabric and polyurethane foam may be combined to form a multi-layer backing layer.

The reinforcing layer, an optional layer of the laminate floor liner product, may be comprised of one or more of the materials discussed with respect to the backing layer. In other words, the reinforcing layer may include a cellulosic material, a woven or nonwoven polymer fabric, polyurethane foam, or combinations thereof. The types of polymers and the weight of the polymers and/or cellulosic material is as described earlier herein.

The first polymer layer is the polymer film layer that is laminated to the top side of the backing layer. This first polymer layer may be extrusion coated onto the backing layer. Alternatively, the first polymer layer may be a separate film product that is then laminated onto the backing layer with or without the use of an additional adhesive. This first polymer layer acts as a moisture and vapor barrier for the top side of the backing layer of the liner product. This first polymer layer can be a polyethylene, polypropylene, polyester or co-polymers thereof. In common examples, the polymer film layer will be polyethylene or polypropylene. The polymer may further include color concentrates and other polymers to increase adhesion to the backing layer and/or to the flooring product that the liner is attached to. An example of such an adhesive polymer is an ethylene methyl acrylate. The density of this first polymer layer can range from 0.8 to 1.52, or alternatively from 0.9 to 0.966. In the example of extrusion coating, the polymer is coated onto the backing layer with melted or molten polymer and then pressured to squeeze and laminate the film onto the backing layer.

The second polymer layer is laminated onto the backing layer on the bottom side of the backing layer opposite the top side of the backing layer. This second polymer layer may be identical or substantially identical with the material and application as related to the first polymer layer. In other words, the second polymer layer may likewise be extrusion laminated onto the backing layer. All of the discussion and materials with respect to the first polymer layer apply equally to the second polymer layer as well.

The third polymer layer is laminated onto the reinforcing layer on the side of the reinforcing layer that is opposite the second polymer layer. This third polymer layer likewise serves the barrier purpose of encapsulating the reinforcing layer and minimizing or preventing the moisture or vapor from permeating the reinforcing layer. This third polymer layer also serves as the bottom of the laminate floor liner product. Accordingly, there may be additional colors or adhesives that are incorporated in this layer for performance specification purposes.

The top adhesion promoting layer may optionally be laminated onto a liner product depending on customer-specific requirements. Some liner customers utilize an adhesive to bond the top polyethylene film layer to the vehicle floor. Other customers, however, may use a different type of adhesive that does not bond as well or as easily to the top polyethylene film layer of the liner. In order to solve this problem at those customer-specific locations, the light weight adhesion promoting layer is laminated on the top of the liner. This adhesion promoting layer may be a light weight paper such as a 65 g/m² (40 lbs/3000 ft²) paper, or alternatively a paper having a weight/thickness between about 48 to 160 g/m² (30 to 99 lbs/3000 ft²). The lightweight paper provides improved adhesion, and it may also absorb less adhesive, relative to a heavier paper, so that the end user could save on the amount of adhesive that is required to bond the liner to the floor. This cellulosic/paper adhesion promoting layer does not provide any moisture barrier. The moisture barrier properties are in the remaining layers of the laminate floor liner described herein. This top adhesion promoting layer may also be a woven or non-woven polymer fabric or polymer foam, all as described earlier herein, in each case depending on a particular adhesive being applied.

### EXAMPLE

In one example, the backing layer is a 69 pound Kraft liner board material. The reinforcing layer is a woven polyethylene fabric that is woven at 8×8 (tapes per inch) and that has a production weight of 65 g/m². The first, second and third polymer layers are formed primarily of low density polyethylene that are extrusion laminated onto either side of the backing layer and reinforcing layer to form a 5-layer laminate product.

In one example, this floor liner will be installed under the subfloor in a recreational vehicle or mobile home. The RV or mobile home vehicle includes a frame with cross members. The liner product with the reinforced layer side down is then adhesively laminated onto a wood panel that is placed over the vehicle frame. A floor covering is then installed over the engineered wood panel. Alternatively, the liner may be adhered directly to the flooring product.

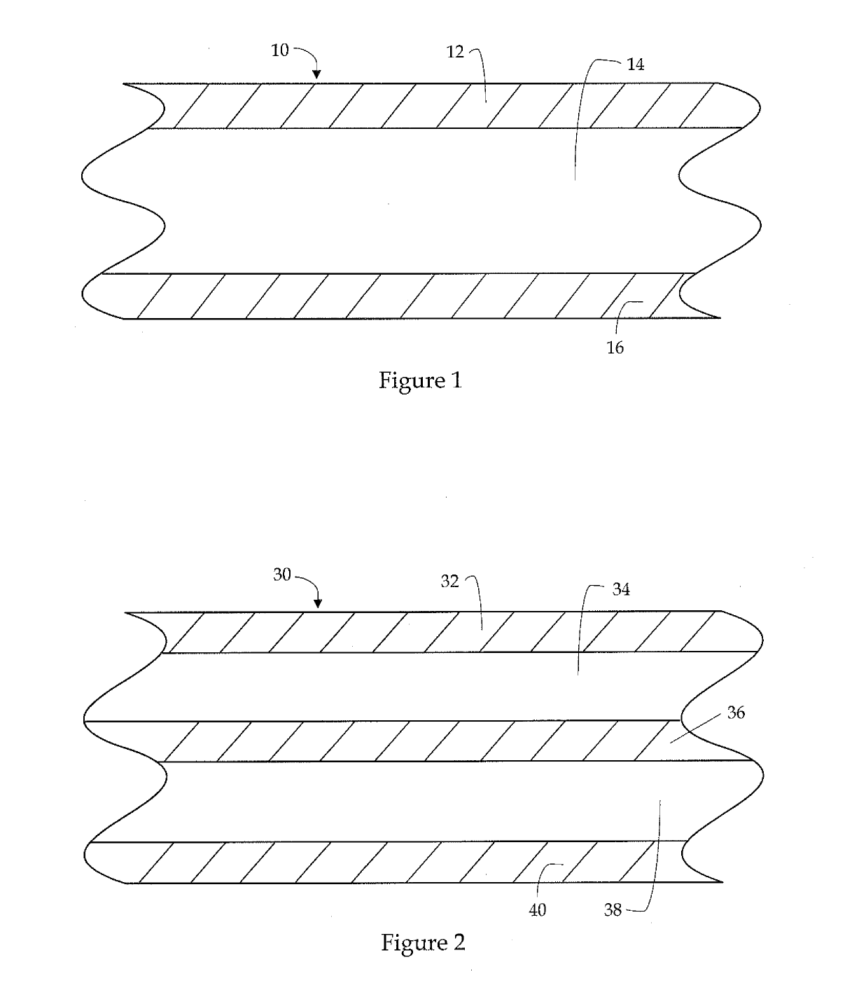

Referring now to FIG. 1, there is shown a cross section of a 3-layer liner 10. The liner 10 includes a backing layer 14 that has first and second polymer layers 12 and 16 laminated onto it. As shown in FIG. 1, the polymer layers 12 and 16 are laminated to the backing layer 14 without any adhesive. It is, of course, possible and may be desirable to use one or more adhesives to better attach the film layers 12 and 16 to the backing layer 14. There is no adhesive layer shown in FIG. 1, but the use of the adhesive would be known to persons of skill in the art.

Referring to FIG. 2, there is a 5-layer liner 30. The liner 30 includes a backing layer 34 and reinforcing layer 38 as described herein. First, second and third polymer layers 32, 36 and 40 are shown laminated around the backing layer 34 and reinforcing layer 38. As with FIG. 1, the film layers 32, 36 and 40 are shown laminated directly to the encapsulated backing layer 34 and reinforcing layer 38. Alternatively, an adhesive layer may be coated onto one or more of the backing layer 34 or reinforcing layer 38 to better adhere the polymer film layers 32, 36 and 40 to those inside layers.

Additionally, it is possible that the backing layer 14 in FIGS. 1 and 34 in FIG. 2 may be impregnated with some adhesive to better join the polymer layers to the backing layers. Similarly, the reinforcing layer 38 may likewise be impregnated with an adhesive to better join the polymer layers 36 and 40 to it.

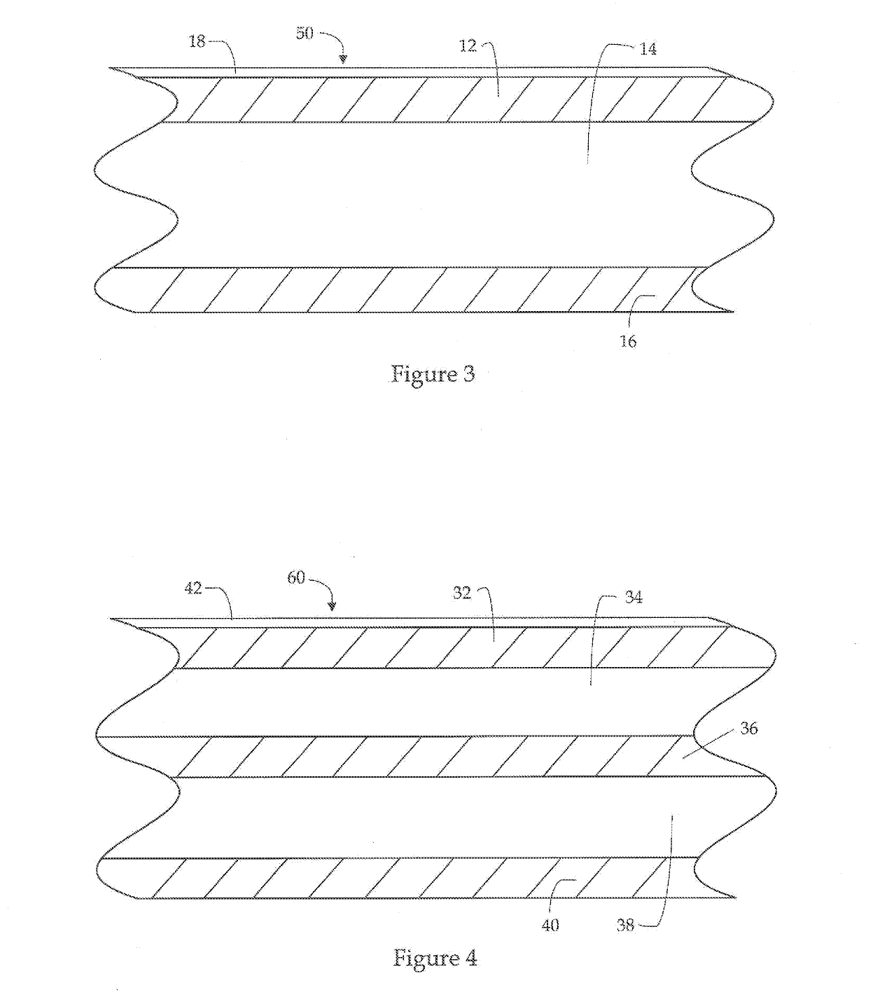

In FIGS. 3 and 4, the liners 50 and 60 respectively are the same as liners 10 and 30 respectively but for the addition of a top adhesion promoting layer 18 and 42 in each case. This new top adhesion promoting layer 18 and 42 is laminated to the polymer film layers 12 and 32 in order to preserve the moisture barrier encapsulation of the backing layers 14 and 34. The new layers 18 and 42 may be added in order to be compatible with specific adhesives that are used by given customers.

Other embodiments of the present invention will be apparent to those skilled in the art from consideration of the specification. It is intended that the specification and Figures be considered as exemplary only, with a true scope and spirit of the invention being indicated by the following claims.

That which is claimed is:

1. A laminate vehicle floor liner comprising a backing layer with a top side and bottom side and having a first polymer layer and a second polymer layer laminated onto the top and bottom sides of the backing layer respectively,
wherein the backing layer is selected from the group consisting of a cellulosic material, a woven or nonwoven polymer fabric, a polyurethane foam and combinations thereof.

2. A laminate vehicle floor liner as described in claim 1, wherein the backing layer is a paper.

3. A laminate vehicle floor liner as described in claim 2, wherein the paper is a Kraft paper.

4. A laminate vehicle floor liner as described in claim 1, wherein the backing layer is a fiberboard.

5. A laminate vehicle floor liner as described in claim 1, wherein the backing layer is comprised of a cellulosic material, and further wherein the cellulosic material is impregnated with an additive selected from the group consisting of a resin, an adhesive, a urethane, a polyester and a mixtures thereof.

6. A laminate vehicle floor liner as described in claim 1, wherein both the first and second polymer layers are comprised of polymer films.

7. A laminate vehicle floor liner as described in claim 1, wherein both the first and second polymer layers are comprised of polymer films that are extrusion coated on the top and bottom sides of the backing layer.

8. A laminate vehicle floor liner as described in claim 1, further comprising a reinforcing layer laminated onto the second polymer layer, wherein the reinforcing layer is selected from the group consisting of a cellulosic material, or woven or nonwoven polymer fabric, a polyurethane foam, and combinations thereof.

9. A laminate vehicle floor liner as described in claim 8, further comprising a third polymer layer laminated onto the side of the reinforcing layer that is opposite the second polymer layer.

10. A vehicle floor assembly comprising a floor and a laminate liner bonded thereto, a laminate vehicle floor liner comprising a backing layer with a top side and bottom side and having a first polymer layer and a second polymer layer laminated onto the top and bottom sides of the backing layer respectively,
wherein the laminate liner comprises the backing layer selected from the group consisting of a cellulosic material, a woven or nonwoven polymer fabric, a polyurethane foam and combinations thereof;
and further wherein the first polymer layer is bonded to the floor.

11. A vehicle floor assembly as described in claim 10, wherein the first polymer layer is adhesively bonded to the floor.

12. A vehicle floor assembly as described in claim 10, wherein the first polymer layer is comprised of polyethylene.

13. A vehicle floor assembly as described in claim 10, wherein the first and second polymer layers are substantially impermeable to water moisture and vapor.

14. A vehicle floor assembly as described in claim 10, wherein the second polymer layer is comprised of polyethylene.

15. A vehicle floor assembly as described in claim 10, further comprising a reinforcing layer laminated onto the second polymer layer, wherein the reinforcing layer is selected from the group consisting of a cellulosic material, or woven or nonwoven polymer fabric, a polyurethane foam, and combinations thereof.

16. A laminate vehicle floor liner as described in claim 9, further comprising a reinforcing layer laminated onto the second polymer layer, wherein the reinforcing layer is selected from the group consisting of a cellulosic material, or woven or nonwoven polymer fabric, a polyurethane foam, and combination thereof.

17. A laminate vehicle floor liner as described in claim 16, wherein the backing layer is comprised of a fiber board and the reinforcing layer is comprised of a woven polymer fabric.

18. A laminate vehicle floor liner as described in claim 9, wherein the backing layer is comprised of a fiber board and the reinforcing layer is comprised of a woven polymer fabric.

19. A laminate vehicle floor liner as described in claim 1, further comprising an adhesion promoting layer laminated onto the first polymer layer on the opposite side of the first polymer layer from the backing layer.

20. A laminate vehicle floor liner as described in claim 19, further comprising an adhesion promoting layer laminated onto the first polymer layer on the opposite side of the first polymer layer from the backing layer.
